(19) United States
(12) Patent Application Publication
(10) Pub. No.: US 2011/0199676 A1
(43) Pub. Date: Aug. 18, 2011

(54) Confocal microscope

(76) Inventors: Sinclair Alastair, Middlesex (GB); Yuri Borisovich Ovchinnikov, Middlesex (GB)

(21) Appl. No.: 12/311,155

(22) PCT Filed: Oct. 29, 2007
(86) PCT No.: PCT/GB2007/004127

§ 371 Date: Jan. 6, 2010

(30) Foreign Application Priority Data
Oct. 30, 2006 (GB) 0621585.9

(51) Int. Cl. G02B 21/06; G02B 21/00

(52) U.S. Cl. 359/385; 359/368

(57) ABSTRACT

A confocal microscope (100) based on a large mode area photonic crystal fibre (5) is described. The microscope may comprise an optical pump source (1) for exciting a sample under study (9), a dichroic beamsplitter (2) to combine the optical paths of the pump and fluorescent light, a lens (3) to couple pump light into the fibre and collimate fluorescent light emerging from the fibre, a large mode area photonic crystal fibre (5), a lens (7) to collimate pump light emerging from the fibre and couple fluorescent light into the fibre, and a lens (8) to focus pump light onto the sample and collimate the resulting fluorescent light. The fluorescent light emitted by the sample (9) is detected by a detector (10). The core (32) of the fibre (5) acts as the aperture of the confocal microscope (100). The large mode area photonic crystal fibre may operate as a single mode fibre over a wide wavelength range (e.g. 400 nm to 2000 nm). This wide wavelength range allows the microscope (100) to be operated with diffraction-limited resolution at any wavelength in this range.

The present invention is concerned with confocal microscopes. In particular, but not exclusively, the present invention is concerned with the use of a photonic crystal fibre (PCF) in confocal microscopy.

Confocal scanning microscopy is a widely used technique in biological, medical, and physical sciences. Typically, a laser, or coherent radiation derived from a laser, is used to illuminate and excite a sample under study. This radiation may be direct from a laser, or synthesised from laser radiation using a nonlinear optical process such as frequency doubling, parametric processes (sum or difference frequency mixing), or supercontinuum generation. These techniques may be used to synthesise particular optical frequencies in the visible or infrared regions of the electromagnetic spectrum, which are not directly accessible using a laser.

The sample under study is illuminated by light, for example derived from a laser, and fluorescent light emitted by the sample is imaged onto an aperture. The aperture defines the volume of the sample from which fluorescence is detected. Fluorescence emitted from inside this volume of the sample is imaged onto the aperture and transmitted towards a detector; any fluorescence emerging from outside of this volume is not transmitted through the aperture and not detected. This principle of the confocal microscope enables the fluorescence to be detected with spatial resolution. The resolution is determined by the magnification of the imaging system together with the size of the aperture. Multiple wavelengths of radiation may be used to excite the sample under study.

A two-dimensional image of the sample can be obtained by scanning the position of the sample with respect to the imaging optics and pump radiation illuminating the sample. A three dimensional image of the sample can be constructed by recording additional two-dimensional images from parallel planes, at different depths inside the sample.

Optical fibres are a convenient means of transporting light and can be used in confocal microscopes.

U.S. Pat. No. 5,120,953 discloses a “Scanning confocal microscope including a single fibre for transmitting light and receiving light from an object”.

The present invention aims to provide an improved confocal microscope.

According to one aspect of the present invention, there is provided a confocal microscope comprising:
a light source for producing light along a first beam path;
a beam path combiner for combining first and second beam paths to form a resultant beam path;
an endlessly single mode optical fibre, having one end coupled to the resultant beam path; and
a detector coupled to the second beam path.

An advantage of the present invention is that the optical fibre is single mode both at:
(i) the wavelength(s) of light emitted by the light source, and
(ii) the wavelength(s) detected by the detector.

Other advantages of the present invention, compared to confocal microscopes that are based on conventional single-mode fibres, are that it affords high photon-collection efficiency and maximal spatial resolution, achievable over a wide range of operating wavelengths, while using one and the same fibre.

In a single-mode fibre, substantially all of the radiation is contained within a single spatial optical mode. The single mode behaviour of such an optical fibre allows, in conjunction with suitable optics, pump light emerging from the far end (i.e. the end not coupled to the beam path combiner) of the fibre, to be focused onto a diffraction limited spot. The single mode behaviour also allows light from the sample to be efficiently coupled to the far end of the fibre.

Diffraction-limited performance is desired in order to maximise the spatial resolution of the confocal microscope. To increase the spatial resolution, it is desired to illuminate the smallest volume of the sample under study (to avoid also illuminating a volume of the sample that is not under study). It is also desired that the confocal microscope detects radiation, e.g. fluorescence, from the smallest volume of the sample under study (to avoid also detecting fluorescence from a volume of the sample that is not under study). Diffraction-limited focussing of the pump light onto the sample, and of the fluorescent light from the sample into the fibre, allows the resolution of the confocal microscope to be maximised.

Prior art fibre confocal microscopes may be single mode at either the pump wavelength or the detection wavelength, but cannot be single mode at both wavelengths unless the pump and detection wavelengths are within the single mode wavelength range of the fibre. Thus unless both wavelengths are within the single mode range of the fibre, prior art confocal microscopes either illuminate a sample volume that is larger than the detection volume, or detect light from a detection volume that is larger than the illumination volume. As those skilled in the art will appreciate, when a fibre is not single mode then light emerging from the fibre will, instead of having an approximately Gaussian beam profile, have other unwanted modes and may have spurious lobes. For example, the beam profile from a non-single mode fibre may not be most bright at the beam centre, and/or may have side lobes.

Preferably, the optical fibre is an endlessly single mode photonic crystal fibre (PCF). PCF fibres typically have an array of “defects” arranged around a core. The core may be glass or may be hollow.

In some embodiments, the PCF may be a large mode area PCF fibre. Large mode area PCF fibres tend to be endlessly single mode. Another advantage of large mode areas is that the effective optical power density along the core is reduced which can also reduce spurious non-linear optical effects.

In other embodiments, the single mode fibre may comprise a Bragg dielectric waveguide or may comprise a step-index fibre having a very small core-cladding index contrast.

In one embodiment, a scanning microscope having a photonic crystal fibre is used to deliver pump light to a microscopic sample under study, and also to deliver fluorescent light emitted by the sample to the microscope's detection system. The sample's position with respect to the focused pump light is scanned in two dimensions, in order to construct a two-dimensional image of the sample. A three-dimensional image can also be constructed using successive two-dimensional images recorded at different depths inside the sample.

In some embodiments, the single mode optical fibre delivering the pump radiation may also perform two other functions. It can form the aperture of the confocal microscope for the fluorescent radiation, and subsequently transport the fluorescent radiation towards the microscope's detector.

Conventional (e.g. non PCF) single-mode fibres typically have an operating wavelength range of about 200 nm (e.g. for operating wavelengths in the 400 nm to 1000 nm region). That is, conventional fibre-based confocal microscopes have a band of 200 nm over which the fibre acts in a single mode, for example 400 to 600 nm or 800 to 1000 nm.

This limits conventional confocal microscopes as the wavelengths of the pump light and of the detected light must be within 200 nm of each other, or it will not be possible to have both the pump light focussed to a diffraction limited spot and the fluorescent light efficiently coupled to the optical fibre.

Conventional confocal microscopes also have the disadvantage that if it is desired to change the pump wavelength from, say, 250 nm to, say, 550 nm then the optical fibre will need to be changed. The optical fibre would also need to be changed if the pump wavelength were to be changed by, say, 20 nm if the change required the use of a different fibre: for example if the pump wavelength were to be changed from 590 nm to 610 nm then the fibre would need to be changed from, say, a 400-600 nm fibre to a, say, 600-800 nm fibre. Thus with conventional confocal microscopes, to be able to achieve optimum resolution over the visible and near infra-red regions, a selection of optical fibres is required, with the most appropriate fibre being selected for use with the wavelengths involved. Changing the optical fibre of a confocal microscope is time consuming as the replacement fibre must then be aligned with the other optical components of the confocal microscope. Given that typical single mode optical fibres have a typical core diameter of the order of 3 to 7 μm (blue to infra-red), the replacement optical fibre must be aligned to better than 1 μm. Such alignment can be performed by piezoelectric manipulators but these increase the cost of the confocal microscope and also introduce a time delay before the replacement optical fibre can be used. In contrast, a confocal microscope that uses a PCF fibre can use a single fibre to guide light in a single mode from about 400 nm to 1000 nm. Thus there is no need to change the fibre in the event that is desired to change the wavelength of the pump light or the wavelength of the fluorescent light being detected.

Some embodiments make use of a large mode area photonic crystal fibre (PCF), which has the property that it is endlessly single mode over a very wide wavelength range, for example 400 nm to 2000 nm. A scanning confocal microscope, based on a large mode area PCF, can achieve the highest spatial resolution, over a wide range of wavelengths, using one and the same fibre for all wavelengths.

A significant property of a large mode area PCF is its ability to efficiently transmit light in a single spatial optical mode, at substantially any optical wavelength. Because of this property, large mode area PCFs are often referred to as being endlessly single mode. By using a large mode area PCF, it is possible to use one and the same fibre, to transmit light at any wavelength from about 400 nm to about 2000 nm, in a single spatial optical mode. Unlike a conventional single-mode optical fibre, the large mode area PCF does not have a cut-off wavelength.

In some embodiments, the large mode area PCF serves three purposes simultaneously. (1) The large mode area PCF acts as a waveguide for the purpose of transporting pump radiation from the pump radiation source towards a sample under study. (2) The core of the large mode area PCF forms the aperture that defines the confocal operation of the microscope. Together with the imaging system, it defines the volume of space within the sample from which fluorescence is detected. (3) The large mode area PCF acts as a waveguide for the purpose of transporting fluorescent light from sample towards the microscope's photodetector.

### DESCRIPTION OF THE DRAWINGS

FIG. 1 shows a schematic diagram of a confocal microscope according to an embodiment of the present invention.

FIG. 2 shows an arrangement which may be used in some embodiments of the present invention, for combining the pump and fluorescence beam paths using a long-pass optical filter.

FIG. 3 shows the cross-section of an example of a large-mode area photonic crystal fibre, illustrating the pattern of air holes around the solid core.

### DETAILED DESCRIPTION OF EMBODIMENTS THE INVENTION

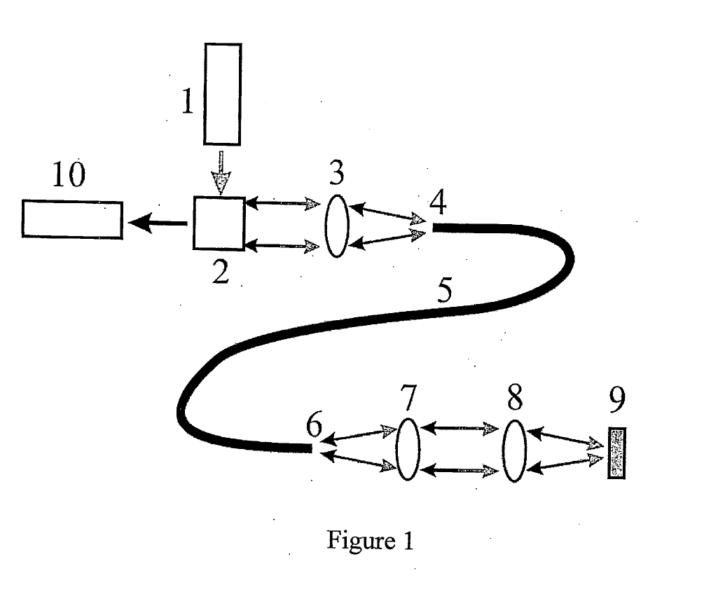

FIG. 1 shows a schematic diagram of a confocal microscope (100) according to an embodiment of the present invention.

A coherent light source (1) is used as the optical pump to excite the sample under study (9). The source of coherent radiation may comprise a laser, or the light may be derived from a laser using other means. Techniques for generating coherent radiation could include a nonlinear process such as frequency doubling, tripling or quadrupling of a laser. Parametric techniques such as optical parametric oscillators, sum-frequency mixing, and difference-frequency mixing are alternative techniques for generating wavelengths not readily accessible by existing lasers. High nonlinearities in optical fibres can be used to generate supercontinuum radiation spanning an octave in optical frequencies, and can be achieved using tapered single mode fibres or highly nonlinear photonic crystal fibres with small core diameters (around 1 μm). The pump radiation source (1) may be pulsed or continuous wave. In other embodiments, the light source (1) need not be a laser although a laser has the advantage that it is possible to more efficiently couple the light to an optical fibre than it is to couple an optical fibre to say, an incandescent bulb or an LED (light emitting diode). A laser also has the advantage of greater spectral intensity.

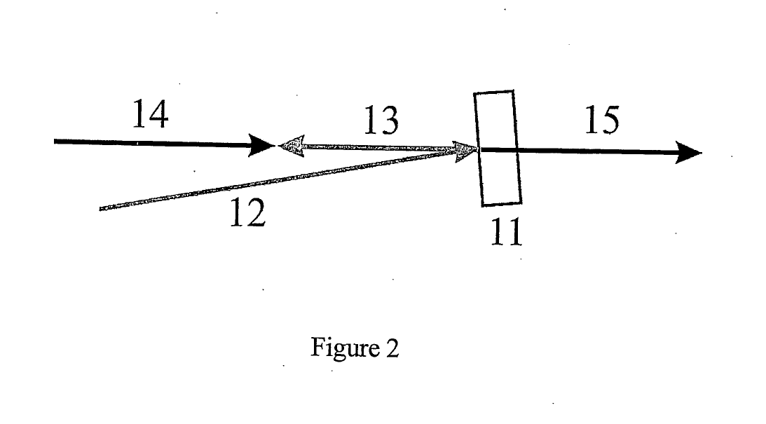

The optical paths of the pump and fluorescent light are overlapped using a means (2) to combine the two wavelengths. The means (2) could be a dichroic beamsplitter that reflects one radiation (e.g. pumping light) and transmits the other (i.e. fluorescence light). Alternatively, the means (2) could be a long pass optical filter that transmits the fluorescence light, but not the pump light, see FIG. 2.

In FIG. 2, a filter (11) is aligned near to normal incidence and the incident pump light (12) is reflected (13) so that it overlaps the same beam path as the fluorescent light (14). The fluorescent light is transmitted (15) by the optical filter but the pump light is not. Multiple yet discrete pump wavelengths could be used in the same instrument by using a series of such beam combining optics.

Returning to FIG. 1, the pump light is coupled into the large mode area PCF using a lens (3). The lens (3) also collimates fluorescent light as it emerges from the fibre end (4). The lens (3) is preferably optimised for performance over a wide range of wavelengths. Typically, aberrations will be minimised and this may be achieved using a multi-element lens.

A large mode area photonic crystal fibre (5) acts as a waveguide to transmit the pump light towards the sample under study (9), whist simultaneously transmitting the fluorescence light from the sample back towards the microscope's detector. A near end of the PCF fibre (5) is located towards the beamsplitter (2; 11). A far end of the PCF fibre (5) is located towards the sample (9).

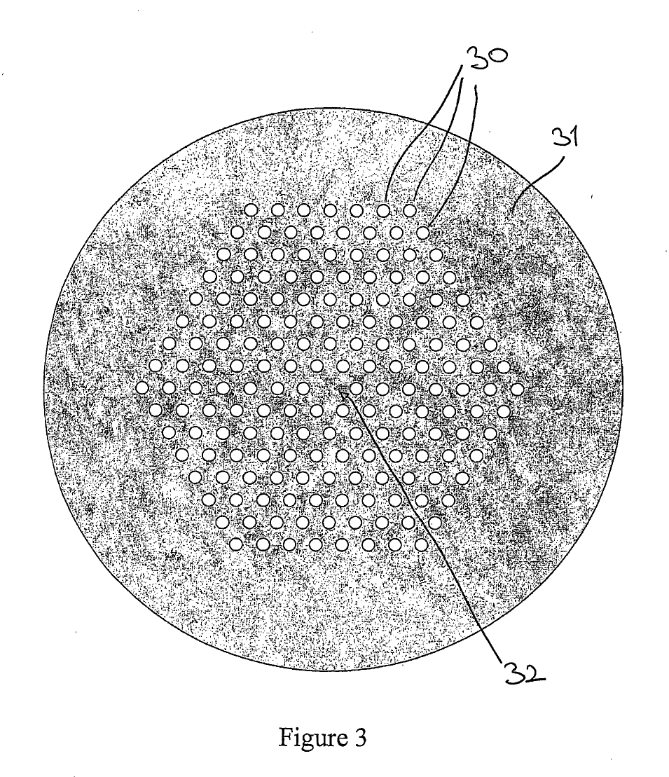

FIG. 3 shows a cross section of an example of the PCF (5). The cross section of the fibre (5) comprises a two-dimensional hexagonal array of air holes (30) in a glass fibre (31). The central hole (32) in the matrix (31) is absent, leaving a solid glass core (32) in which the guided light travels. The fibre core typically has a characteristic diameter in the range 8 μm to 15 μm. For these fibres, the hole (30) separation is typically similar to the size of the core diameter. Fibres such as LMA8, LMA10 and LMA15 available from Crystal Fiber A/S (Birkerod, Denmark) are examples of fibres that could be used in the invention. However fibres with, for example, core diameters of 35 μm are also available and could be used. For applications where the polarisation of the pumping light and the fluorescence light is important, it is also possible to use polarisation-maintaining large mode area fibre; examples of such fibres are LMA-PM-10 and LMA-PM-16, also from Crystal Fiber A/S.

An advantage of the large mode area PCF (5) is its endlessly single mode behaviour. This means that it will transmit light of any wavelength over an extremely wide range, for example 400 nm through to 2200 nm, in a single spatial optical mode, similar to the TEM₀₀ mode of a Gaussian beam. This broadband single mode behaviour cannot be achieved by a conventional single-mode optical fibre. Typically, a conventional single-mode optical fibre (that has been designed for use in the 400 nm to 1000 nm region) will have an operating range of around 200 nm, so several fibres (400 nm to 600 nm; 600 nm to 800 nm; and 800 nm to 1000 nm) are required to achieve single mode performance over this range.

In some embodiments, the light source (1) may be arranged to emit light of a first wavelength and the detector (10) may be arranged to detect light of a second wavelength. The first and second wavelengths may differ by about 200 nm. More generally, the wavelengths may differ by any integer in the range 180 nm to 2200 nm, for example 180, 181, 182, . . . , 2198, 2199, 2200 (of course, optical sources typically emit light over a range of wavelengths, with a peak wavelength within the range, and the peak wavelength need not coincide with an integer). The light source (1) and detector (10) may include filters or diffraction gratings to select a particular wavelength or to select a band of wavelengths. In other words, the fibre (5) provides single mode performance over a waveband that preferable has a width of 180 nm to 2200 nm.

In a large mode area PCF the mode profile has only one maximum, which is located at the centre of the mode and is smoothly varying, similar to a TEM₀₀ Gaussian mode. This single spatial mode operation is desired so that the pump light can be focused down to a minimum spot size. The fundamental limit of the focused spot size is governed by the wavelength of the light to be focused, and the f-number of the focusing lens. For a given focusing lens, the minimum focused spot size is achieved when a single spatial mode fills the aperture of the focusing lens. Being able to focus to the minimum spot size ensures that only the smallest area of the sample under study is illuminated, and maximises the resolution achieved when pumping the sample. The fact that a large mode area PCF does not have a cut-off wavelength (unlike conventional single-mode fibres) means that light of any wavelength in its large operating range can be transmitted in a clean, single, spatial optical mode, and subsequently focused down to a minimum spot size. Appropriate lenses may be used to focus the light; this is described later. With conventional multi-element lenses, a minimum spot size with waist diameter 2wₒ=λ (where λ is the wavelength of the pump light) is achievable.

Another advantage of the large, mode area PCF (5) is its large core diameter. The pump laser (1) can induce unwanted nonlinear processes in an optical fibre, and these unwanted processes become more significant as the intensity of the light increases. In a large mode area PCF, the pump laser intensity is reduced, due to the larger core area, when compared to a conventional single-mode fibre. As a result, nonlinear processes in a large mode area PCF are likely to be between 100 and 1000 times less pronounced than in a conventional (non PCF) single mode fibre.

In this embodiment the PCF core (32) forms the aperture of the confocal microscope (100). This aperture enables the microscope to operate in the confocal regime and thereby resolve individual points in space within the sample (9) at a microscopic level. Together with the magnification of the lens system composed of lenses (7) and (8), the aperture (32) determines the absolute resolution of the microscope. Fluorescence from the sample (9) is imaged by the lenses (7, 8) onto the core (32) and thus is efficiently coupled into the PCF fibre (5) and is transported towards a detector (10). The pumping radiation and the fluorescence share the same beam path in the optical fibre (5) and through the lenses (7) and (8); a result of this common path configuration is the consequential alignment of the fluorescence into the fibre core (32).

The two lenses (7) and (8) are used to manipulate the pump light for illuminating the sample and the fluorescent light that is emitted by the sample. The pump light emerging from the optical fibre is collimated by lens (7) and focused onto the sample by lens (8). The fluorescent light emitted by the sample is gathered by lens (8) and focused into the optical fibre core (32) of the far end (6) of the fibre (5) by lens (7). To achieve optimum performance, both of these lenses may be optimised for performance over a wide range of wavelengths. Typically this may be achieved by using multi-element lenses in order to reduce aberrations in the optical system. Such lenses are required in order to enable the pump light to focus down to the smallest spot size without degrading the circular mode. This ensures that the light can be focused to the diffraction-limited spot size if desired. Furthermore, it ensures efficient capture of fluorescent light into the optical fibre. In alternative embodiments, the lenses (7) and (8) may be replaced by a single lens although this may reduce the optical efficiency of the confocal microscope (100).

The fluorescent light is emitted by the sample and travels through the optical fibre. After emerging from the near fibre end (4), i.e. the end adjacent the beamsplitter (2), the fluorescent light is transmitted by the beam-combining device (2), and travels towards the detector (10) where its properties are detected and/or characterised. The amplitude of the fluorescent light can be detected by devices such as: a photodiode, photomultiplier, avalanche photodiode, or charge-coupled device (CCD) camera. If the nature of the fluorescent light is to be characterised beyond its amplitude, then other instruments may be incorporated into the detection system. For spectral characteristics, a spectrometer or monochromator would be employed. Interferometers of various types can be used to characterise the first- and second-order coherence properties of the fluorescent light; such interferometers may be used to characterise the emission characteristics of a sample (9) that is a quantum dot. For temporal characteristics, instrumentation for correlating the arrival time of the detected photons can be incorporated. Fluorescence lifetimes can be measured by detecting the arrival time of fluorescent photons with respect to an excitation by a pump laser pulse.

A two-dimensional image of the sample can be obtained by scanning the position of the sample with respect to the imaging optics and pump radiation illuminating the sample. A three dimensional image of the sample can be constructed by recording additional two-dimensional images from parallel planes, at different depths inside the sample.

Scanning the position of the sample with respect to the imaging optics and focused pump radiation can be achieved by several methods. In one method, the optical imaging head of the microscope, consisting of the fibre end (6) and lenses (7) & (8), is held in a fixed position and the sample (9) is scanned. A three-dimensional translation stage (101), with piezo-electric translation devices to actuate the fine scale translation, is an example of how to achieve this. In another method, the position of the sample (9) is fixed and the microscope's optical imaging head (6, 7, 8) is scanned. A three-dimensional translation stage (not shown), for example with piezo-electric actuators for fine scale translation, can be used for this purpose. In yet another method, the fibre end (6) may be moved in a plane normal to the fibre (5).

As those skilled in the art will appreciate, the holes (30) of a PCF fibre are sometimes “collapsed” at each end (4, 6) of the PCF fibre in order to hermetically seal the ends of the fibre. In such collapsed PCF fibres, the holes (30) extend along the majority of the length of the PCF fibre but the holes are collapsed, for example by surface tension as a result of the application of intense heat to the fibre (5), towards the ends of the fibre, for example the last 50 μm to 10 mm at each end of the fibre. When collapsed fibres are used as part of the microscope (100), the effective aperture of the fibre (5) will not be at the end faces (4, 6) of the fibre but will be buried inside the fibre, about 50 μm to 10 mm from the actual end faces (4, 6).

As those skilled in the art will also appreciate, other types of fibres that provide an endlessly single mode may also be used. For example, a step-index fibre (i.e. a non-PCF fibre) having a low index contrast between the core and the cladding allows a larger core diameter, although such fibres are currently difficult to fabricate due to the low refractive index difference (e.g. 0.001 or lower) between the core and the cladding.

As those skilled in the art will appreciate, the embodiments mentioned above may be modified and/or combined.

### LIST OF REFERENCE NUMERALS

(1) optical pump source
(2) means to combine two beam paths
(3) lens to focus pump light and collimate fluorescence light
(4) fibre end
(5) large mode area photonic crystal fibre
(6) fibre end
(7) lens to collimate pump light and focus fluorescence
(8) lens to focus pump light and collimate/fluorescence
(9) sample
(10) photodetector
(11) incident pump light
(12) long pass optical filter
(13) reflected pump light
(14) incident fluorescent light
(15) transmitted fluorescent light

In an embodiment, there is provided a confocal microscope (100) based on a large mode area photonic crystal fibre (5). The microscope may comprise an optical pump source (1) for exciting a sample under study (9), a dichroic beamsplitter (2) to combine the optical paths of the pump and fluorescent light, a lens (3) to couple pump light into the fibre and collimate fluorescent light emerging from the fibre, a large mode area photonic crystal fibre (5), a lens (7) to collimate pump light emerging from the fibre and couple fluorescent light into the fibre, and a lens (8) to focus pump light onto the sample and collimate the resulting fluorescent light. The fluorescent light emitted by the sample (9) is detected by a detector (10). The core (32) of the fibre (5) acts as the aperture of the confocal microscope (100). The large mode area photonic crystal fibre may operate as a single mode fibre over a wide wavelength range (e.g. 400 nm to 2000 nm). This wide wavelength range allows the microscope (100) to be operated with diffraction-limited resolution at any wavelength in this range.

The disclosure of GB 0621585.9, from which the present application claims priority, is hereby incorporated by reference.

1. A confocal microscope comprising:
a light source;
a detector;
an endlessly single mode optical fibre; and
a beam combiner for coupling light from the light source to a first end of the optical fibre, and for coupling light from the first end of the optical fibre to the detector.

2. A confocal microscope according to claim 1, wherein a core of the fibre defines a confocal aperture of the microscope.

3. A microscope according to claim 1, wherein the fibre comprises a PCF fibre.

4. A microscope according to claim 1, wherein the light source comprises a laser.

5. A microscope according to claim 1, wherein the detector comprises a photodiode.

6. A microscope according claim 1,
wherein the light source is arranged to emit light of a first wavelength,
wherein the detector is arranged to detect light of a second wavelength, and
wherein the first wavelength differs from the second wavelength by more than 200 nm.

7. A confocal microscope according to claim 1, comprising one or more optical elements arranged to couple a second end of the optical fibre with a sample.

8. A microscope according to claim 1, comprising a scanner to optically scan a sample relative to a second end of the optical fibre.

9. A microscope according to claim 7, wherein the scanner is arranged to move the sample relative to the one or more optical elements.

10. A microscope according to claim 1, wherein the beam combiner comprises a dichroic beamsplitter.

11. A confocal microscope comprising a photonic crystal fibre.

12. A confocal microscope according to claim 11, wherein the photonic crystal fibre is arranged to act as an aperture of the microscope.

13. A method of performing microscopy to image a fluorescent object, using a confocal microscope having an endlessly single mode optical fibre, a detector and a pump source, comprising the step of:
using the detector to image fluorescence from the object that differs from the wavelength of the pump source by more than 200 nm.
